(19) United States
(12) Patent Application Publication
(10) Pub. No.: US 2025/0108387 A1
(43) Pub. Date: Apr. 3, 2025

(54) Segmented Screen Assembly for Cuttings Dryer

(71) Applicant: Elgin Separation Solutions Industrials, LLC, Stafford, TX (US)

(72) Inventors: Michael Rai ANDERSON, Sugar Land, TX (US); Emad BABRI, Katy, TX (US)

(21) Appl. No.: 18/903,026

(22) Filed: Oct. 1, 2024

Related U.S. Application Data
(60) Provisional application No. 63/587,287, filed on Oct. 2, 2023.

(51) Int. Cl. B04B 7/02; E21B 21/06

(52) U.S. Cl. CPC B04B 7/02; E21B 21/065

(57) ABSTRACT

A screen assembly for a cuttings dryer has a frustoconical screen assembly that has a plurality of screen segments. The individual screen segments each extend along the sidewall of the screen assembly from the lower part of the screen assembly to the upper part of the screen assembly. Each screen segment may be replaced by accessing the screen segment in the CD body, and replacing the damaged or worn segment, without the need to remove the entire screen, or to remove the undamaged screen segments. A cutting dryer includes an improved screen assembly including a plurality of screen segments. A method for replacing a screen segment is provided.

### RELATED APPLICATION

This application claims benefit of U.S. Provisional Application Ser. No. 63/587,287 field Oct. 2, 2023, the entire contents of which are incorporated herein by reference.

### TECHNICAL FIELD

This disclosure relates to separation devices for processing solids-containing streams and, more particularly, to centrifugal dryers, specifically those in the nature of vertical cuttings dryers, and to improved screen designs for vertical cuttings dryers.

### BACKGROUND

There is a continuing need for improvement in efficiencies in use and replacement of screens for centrifugal dryers used for separating solid particulate from a liquid slurry. Such screens generally are known, as described in, for example, U.S. Pat. No. 10,865,611 issued Dec. 15, 2020, the contents of which are incorporated herein by reference for all purposes.

### SUMMARY OF THE DISCLOSURE

The present disclosure includes an improved design for a screen for a centrifugal dryer, also known as a cuttings dryer (“CD”). CDs may be configured in various forms and formats, including a vertical CD. In the improved design disclosed herein, a CD screen assembly is provided, wherein a screen is segmented into a plurality of screen segments. The individual segments each extend in a direction along an outer sidewall of the screen assembly from the lowest part of the screen assembly to the uppermost part of the screen assembly, in a vertical direction along a longitudinal axis of the screen assembly. In this manner, when a screen segment suffers damage or wear during use, the screen segment may be replaced by accessing the screen from an exterior side of the screen assembly. In an embodiment, the access is provided by opening an outer side access door formed in outer shell of the CD, and replacing the damaged or worn segment, without the need to remove the entire screen assembly, or the remaining segments. A cutting dryer includes an improved screen assembly according to the following disclosure.

This summary is not intended to identify key or essential features of the claimed subject matter, nor is it intended to be used as an aid in limiting the scope of the claimed subject matter. Further examples, forms, objects, features, advantages, aspects, and benefits shall become apparent from the following description and drawings.

### BRIEF DESCRIPTION OF THE DRAWINGS

FIG. 1 is a diagram showing an exploded side perspective view of a screen assembly according to an example in this disclosure.

FIG. 2 is a diagram showing a side perspective view of a screen frame of a screen assembly according to an example.

FIG. 3 is a diagram showing a side perspective view of a screen assembly according to an example.

FIG. 4 is a diagram showing a side perspective view of a screen segment according to an example.

FIG. 5 is a diagram showing a side perspective view of an inner reinforcement frame of a screen segment according to an example.

FIG. 6 is a diagram showing a perspective view of two lock bars according to an example.

FIG. 7 is a diagram showing a perspective view of a screen assembly installed in a cuttings dryer according to an example.

FIG. 8 is a diagram showing a perspective view of a cuttings dryer according to an example.

### DETAILED DESCRIPTION OF ILLUSTRATIVE EMBODIMENTS

For the purposes of clearly, concisely, and exactly describing illustrative embodiments of the present disclosure, the manner, and process of making and using the same, and to enable the practice, making and use of the same, reference will now be made to certain examples, including those illustrated in the figures, and specific language will be used to describe the same. It shall nevertheless be understood that no limitation of the scope of the invention is thereby created, and that the invention includes and protects such alterations, modifications, and further applications of the examples as would occur to one skilled in the art.

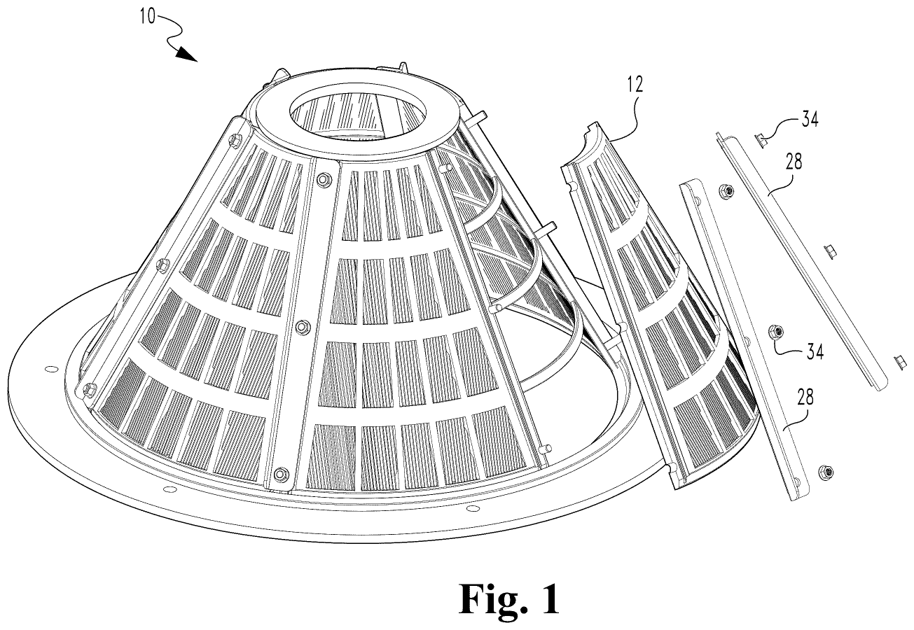

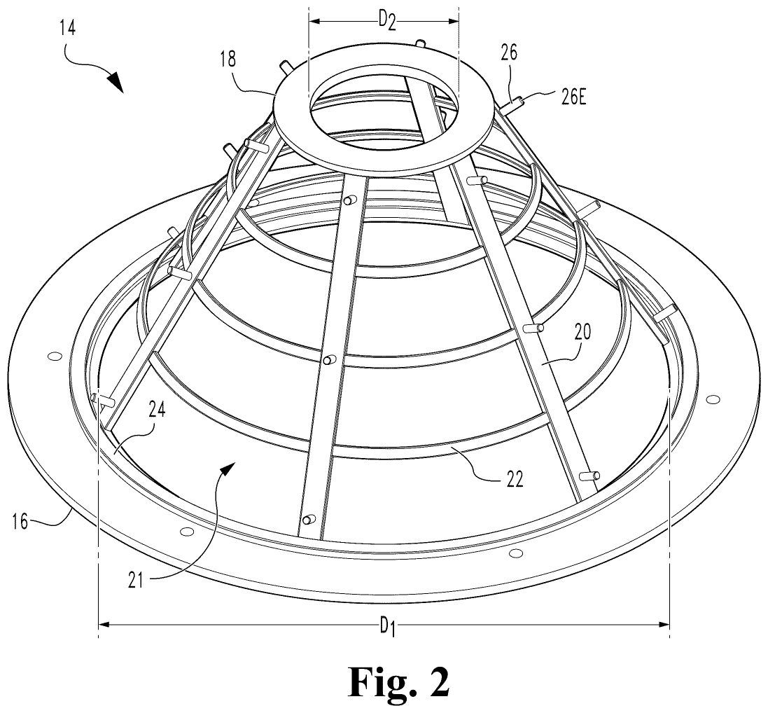

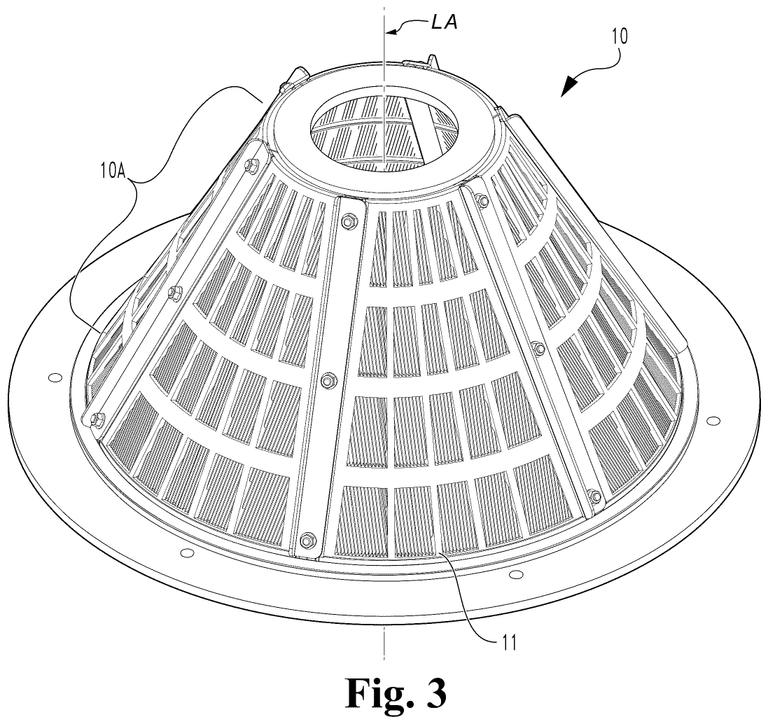

FIG. 1 is a diagram showing an exploded side perspective view of a screen assembly according to an example in this disclosure. As is known in the art, a screen assembly for a centrifugal dryer is configured to be driven by a motor to rotate around a central longitudinal axis LA of the screen assembly during the screening operation conducted within the centrifugal dryer. A screen assembly 10 includes a screen frame 14 (see FIG. 2) and a screen 11 (see FIG. 3). The screen 11 is formed by a plurality of screen segments 12, 12 that are removably installed onto the frame 14 of the screen assembly 10. The installation may be arranged so that the lateral edge side 12A of at least one of the segments 12 abuts the lateral side 12A of an adjoining segment 12. In an embodiment, the screen segments abut one another in a direction extending from the lowermost to the uppermost portion of the screen assembly 10.

FIG. 2 is a diagram showing a side perspective view of a screen frame of a screen assembly according to an example. As seen in FIG. 2, the screen assembly 10 is formed in essentially a frustoconical shape, with the screen segments 12, 12 supported by an inner frame 14 also formed in a frustoconical shape. The screen segments 12, 12 are joined to the frame 14 form a sidewall 10A of the screen assembly. The sidewall 10A forms an outer surface of the screen assembly 10, the outer surface sloping inwardly in a direction extending from a lowermost portion of the screen assembly 10 to the uppermost portion of the screen assembly 10. The screen segments 12, 12 each include a plurality of screen openings that permit liquids and fines smaller than the openings to escape from the interior space within the screen to the outside of the screen during rotation of the screen assembly 10 inside the CD.

The segments 12, 12 each are separately mounted to the screen frame 14. The screen frame 14 has a first end (bottom or lower) configured as a frame base 16 generally in the form of a ring-shaped flange which forms the lowermost portion of the frustoconical screen assembly 10. The screen frame 14 has a second end (top or upper) configured as a frame top 18 generally in the form of a flat circular flange, forming the uppermost portion of the frustoconical screen assembly 10. The frame top 18 has a diameter D2 that is smaller than a diameter D1 of the frame base 16, in accord with the frustoconical shape of the screen frame 14. In an example, the screen assembly overall may have a cylindrical shape (D1 equal to D2) instead of a frustoconical shape.

The frame base 16 and frame top 18 are connected to one another by a plurality of support bars 20, 20 that extend from the base 16 to the top 18 along the sidewall 10A. At least one of the support bars 20 may extend substantially along straight lines formed between the first end of the frame and the second end of the frame. In an example, at least one of the support bars substantially aligns with a generatrix of the frustoconical shape of the frame. The support bars 20, 20 are connected to a plurality of stiffener support rings 22, 22, forming an interior support cage along the sidewall 10A. The base 16, top 18, support bars 20, 20, and support rings 22, 22 may be connected to one another as shown in FIG. 2 by welding or other typical means.

The base 16 may have a base screen lock ring 24 that extends upwardly from the upper surface of the base 16. The base screen lock ring 24 forms a support ring that holds inwardly the lowermost portions of the screen segments 12, 12 when the segments are installed on the frame 14, with segments' lower edges secured inside the lock ring 24. The screen lock ring 24 helps to prevent the lower part of the segment 12 from flexing outwardly out of position during rotation of the screen assembly.

As seen in FIG. 2, extending outwardly from the support bars 20, 20 are a plurality of studs 26, 26. The studs 26, 26 extend outwardly from the support bars 20, 20 and are shaped to engage with indentations or apertures formed along the lateral sides of at least one screen segment 12. The apertures or indentations are in the form of stud guides 40.

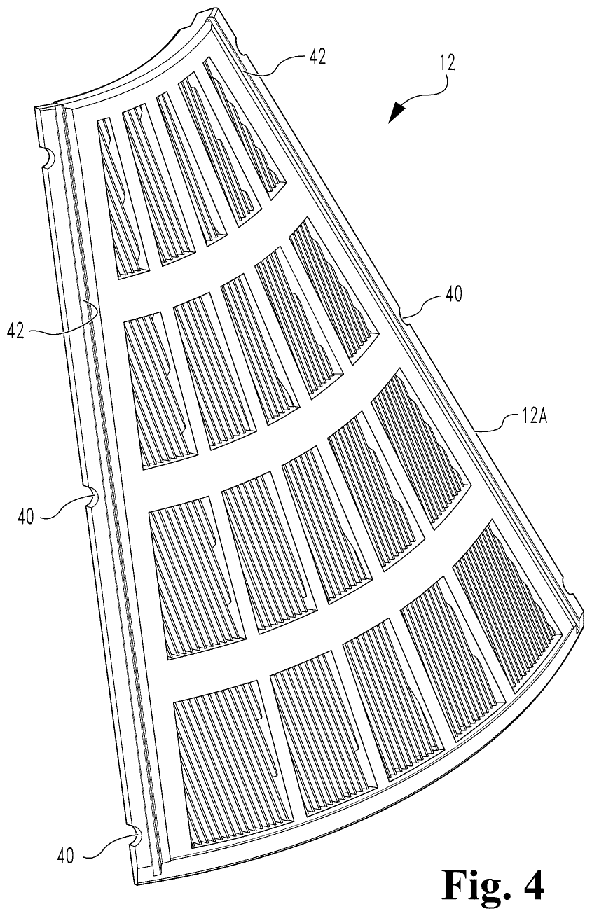

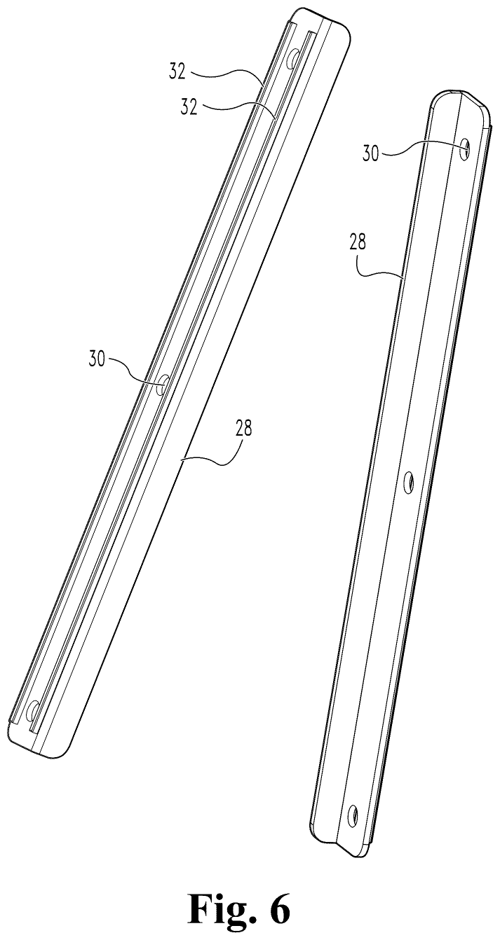

In one example of a manner of securing segments 12, 12 to the frame 14, each one of the studs 26 may be inserted into a stud guide 40 (see FIG. 4) formed on a lateral edge 12A of a first segment 12. The stud 26 similarly may be inserted into a stud guide 40 formed on the abutting or adjoining lateral edge 12A of a second segment 12 that is positioned next to the first segment 12. Thus, the stud 26 may support each of the lateral edges 12A, 12A of two adjoining segments 12, 12. Then the protruding distal end 26E of the stud 26 may further be inserted into an aperture 30 formed in a lock bar 28. Each lock bar 28 may include gripping ribs 32 (see FIG. 6) formed to engage with and hold the lateral edge 12A of a segment 12 in a secured position between the lock bar 28 and the exterior surface 20E of the support bar 20. In one example of means of engagement, the distal end 26E of each stud 26 may be shaped to engage in a secure manner with a locknut 34. In this example of engagement, the locknut 34 has internal threads that engage with threads formed on the distal end 26E of the stud 26 when tightened, to make a secure engagement with the stud 26, thus holding the lock bar 28 against the side of the segment 12, and thus securing the segment 12 to the exterior surface 20E of the support bar 20 of the frame 14.

In this example, each segment 12 may separately be removed from the frame 14 by disengaging the locknuts 34, 34 and disengaging the lock bar 28 securing that segment 12 to the frame 14, in an operation to remove a damaged or worn segment. A replacement segment 12 then is placed in the position of the removed segment 12, and the replacement segment is secured to the frame 14 by engaging the studs 26 through their respective mating stud guides 40, through a lock bar aperture 30, and then engaging the threads on the distal end of the stud 40 with the threads of a locknut 34. Other means and examples of accomplishing the engagement are contemplated.

In an example, the locknut 34 is formed of high strength steel and has a serrated flanged design. In an example, the lock bar 28 has a channel profile provided in the region of its aperture 30 to accommodate the locknut 34. In an example, the lock bar 28 is formed of stainless steel. In an example, an aperture 30 of the lock bar 28 may be configured to have a surrounding recessed portion, so that the locknut 34 in its secured position against the lock bar 28 may positioned to have its locknut outer portion in a flush position with respect to the outer surface of the lock bar 26. The recessed portion thus can limit the exposure of the locknut 34 to wear. In other examples, the lock bar 28 may include a leading wall of the lock bar 28 that protects the outer portion of the locknut 34 from wear.

FIG. 3 is a diagram showing a side perspective view of a screen assembly according to an example. The screen assembly is shown in an assembled condition with screen segments 12 forming the screen 11 mounted on the frame 14 with the lock bars 28 holding the screen segments in place. As in an example shown in FIG. 3, the lateral sides 12A of the screen segments are configured to be proximate to the first end (base 16) of the frame 14 and also to be proximate to the second end (top 18) of the frame 14. That is, the segments may be configured extend all of the distance between the frame base and the frame top. In other examples, the segments extend only part of the distance between the frame base and the frame top.

FIG. 4 is a diagram showing a perspective side view of a screen segment according to an example. The screen segment has lateral sides 12A and a bottom side that is curved to fit and be secured within the base screen lock ring 24. Stud guides 40, 40 are formed in lateral edge sides 12A of the screen segment 12. Molded grooves 42 are formed in the lateral edge side of the screen segment in a shape that is adapted to engage in a secured manner with the lock bar 28 in an installed condition. In an example, the screen segment 12 preferably is formed primarily of polyurethane.

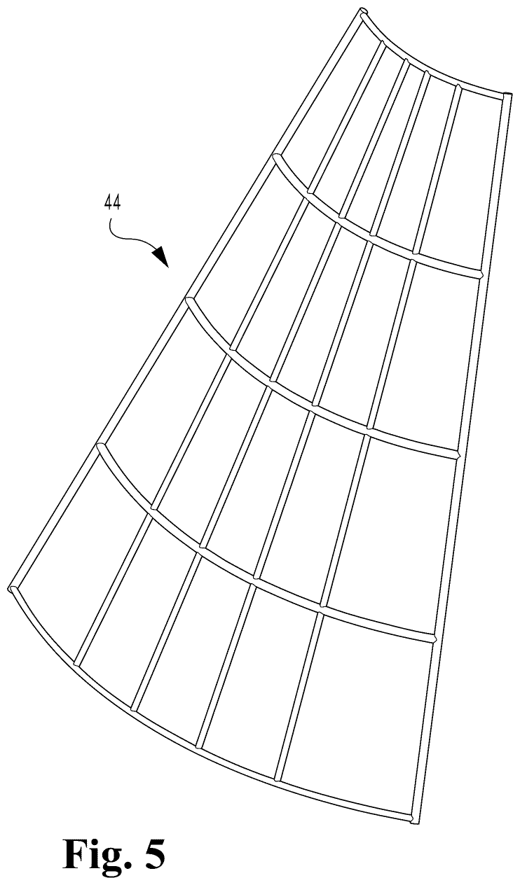

FIG. 5 is a diagram showing an inner reinforcement frame of a screen segment according to an example. In an example, the screen segment 12 includes a metal inner reinforcement frame 44 that forms a supportive grid that is molded inside the polyurethane body of the segment 12. The reinforcement frame 44 helps support the shape of the segment 12 against deformation during use. The reinforcement frame 44 may be formed by welding round metal rod portions together to form the metal grid shape of the reinforcement frame 44. In an example, the metal rod portions have a diameter of ¼inch (0.25 inch). Then the reinforcement frame 44 may be molded within the polyurethane body of the segment during manufacture of the segment 12.

FIG. 6 is a diagram showing a perspective view of two lock bars according to an example. As described above, the lock bars 28, 28, may include apertures 30 for receiving insertion of studs 26. The lock bars 28, 28 also may include gripping ribs 32 that are configured to abut edge portions of screen segments 12 to aid in securing the segments 12 firmly between the lock bar 28 and the exterior surface 20E of the support bar 20 during operation of the CD.

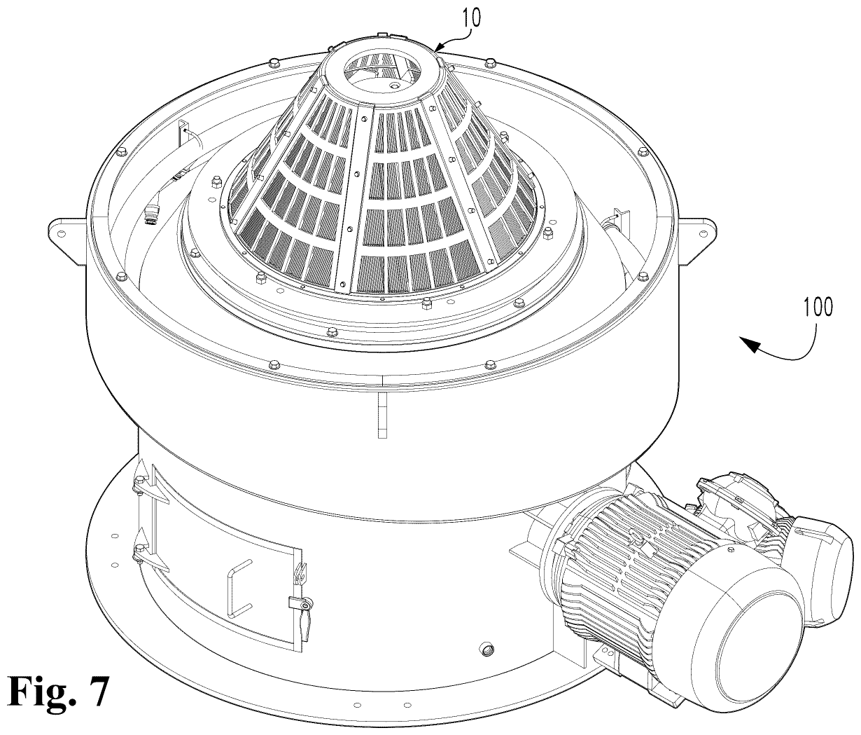

FIG. 7 is a diagram showing a perspective view of a screen assembly 10 installed in a cuttings dryer 100 according to an example. It is noted that the vertical CD 100 is depicted without its outer cover. The outer cover would retain liquids and small fines that have been ejected through the screen segments of the screen assembly 10 during rotational operation of the screen assembly 10 within the cover. The outer cover would include means for accessing screen segments for replacement, such as via an opening such as a door formed in the outer cover.

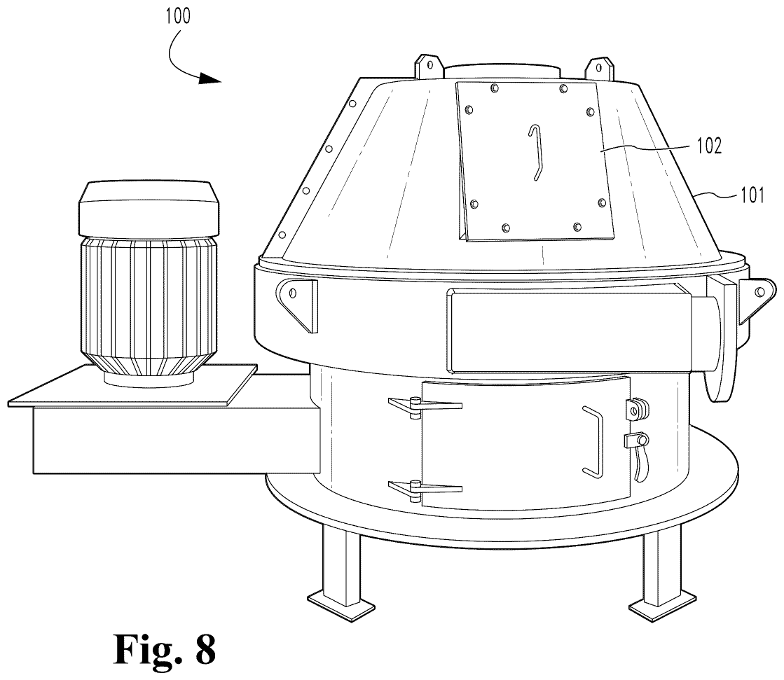

FIG. 8 is a diagram showing a perspective view of a cuttings dryer 100 according to an example. In this view, an outer upper cover 101, in the nature of an outer water shield, of the cuttings dryer 100 is installed over a screen assembly 10, which not visible in this view because it is installed within the outer upper cover 101. An outer access door 102 is provided in the outer upper cover 101. The access door 102 permits operators to access the screen segments 12, 12 for replacement. With the cuttings dryer 100 configured to have both the access door 102 and the screen assembly 10 having separately removable screen segments 12, 12, instead of having to remove the entire upper section of the CD to replace a screen, each separate segment 12 of the screen assembly 10 can be removed out of the cuttings dryer 100 through the side access door 102, and a replacement screen segment 12 can be inserted through the access door 102 and installed onto the screen frame 14. In this manner, repairs can be made without having to remove the upper cover 101 and the upper feed systems (not shown) will not need to be removed as was the case in prior designs.

Testing Summary. Exemplary finite element analyses (FEAs) were conducted on screen segment test examples in order to assess and visualize levels of deformation expected to occur under application of dynamic force to screen segment examples according to the invention herein. A high level of deformation is undesirable as it may render the scraping function of the screen ineffective due to the loss of surface contact between the flites/blades of the CD and the screen panel of the CD.

FEA conducted on a text example of a screen segment 12 according to the disclosure herein, in connection with application of CD maximum rotation speed, yielded a maximum displacement of 21.75 mm (0.8564 inches) in the test example. FEA was conducted on a test example of a screen segment 12 that included an optional feature of an inner reinforcement frame 44, forming a supportive grid, molded inside the polyurethane body of the segment 12 in the test example. An example of such a reinforcement frame 44 is shown in FIG. 5. FEA was conducted on such a reinforced text example in connection with application of CD maximum rotation speed to assess and visualize the deformation that occurs under the dynamic force. A maximum displacement of 0.000029 mm (0.000754 inches) was found as the displacement value in the reinforced test example. The comparison of the results of the testing described herein may illustrate the lower maximum displacement that can be found with use of the exemplary design that includes the optional inner reinforcement frame 44 in the body of the segment 12.

Benefits of the disclosed design and features include the following, in contrast to prior designs.

The segmented screen assembly as claimed offers the benefit of permitting the replacement of a damaged screen segment from the exterior side of the screen assembly. Prior designs had screens that were replaceable only by removing the entire assembly from the CD in order to replace a damaged screen. This makes screen replacement operations slower and more difficult and disruptive. In contrast, the screen assembly disclosed herein provides screen segments that are individually mounted on an exterior side of the assembly. The segments are detachable and replaceable independently of one another. The screen segments are mounted on, and removable from, the exterior side of an interior frame of the assembly, facilitating easier replacement without removing the entire assembly.

The segmented screen design as disclosed herein has a unique internal structure to prevent plastic deformation under high centrifugal forces. Prior art designs require an external structure in the form of basket to prevent deformation, whereas in the disclosed examples herein, no outer cage or basket is required, thus reducing the weight of the rotating body, and thus effectively reducing torque on the motor powering the rotation of the screen assembly, yielding lower power consumption due to reduced dynamic loads. An interior frame 44 molded within a screen segment 44 helps to prevent deformation during operation.

At present, CD screens typically are built via a welded plurality of individual triangular “profile” wires. Typical screens on the market are made of steel, some of which are then dipped in a hard chrome process to provide additional abrasion resistance. In contrast to the typical CD screens, the design and features disclosed herein provide a sectional composite polyurethane molded screen, ensuring an extended screen lifespan, while its unique sectional configuration enables operators to replace only the damaged portions, rather than the entire screen. Polyurethane is contemplated by the inventors as a preferred material for forming the screen, but various other composite materials may be considered, including plastic and fiberglass. An optional interior frame 44 within a segment 12 may be added to limit deformation in operation and extend the lifespan of the screen or its segments.

The disclosed design and features provide advantages that cannot be achieved through the current singular-piece and/or metal CD screen design. Some typical current CD screens are manufactured out of carbon steel, and most do not include the additional hard chroming. Typical CD screens are constructed from steel wedge wire as a single, indivisible piece. Due to the uncontrolled and often non-homogeneous nature of the feed entering CD machines, wear on the CD screen tends to be irregular, unconcentrated, and entirely unpredictable. A single large rock can breach the CD screen, causing irreparable damage and necessitating a complete screen replacement. Once the CD screen has been thus “punched,” the screen becomes ineffective immediately. This situation can arise unexpectedly, drastically reducing the screen's lifespan when subjected to such unpredictable feed conditions. The repercussions of foreign objects penetrating the screen pose a considerable risk. The design and features disclosed herein solution eliminate the need for a full-screen replacement, by breaking the screen into independent sections arranged in vertical side-by-side abutment. By arranging segments in this direction and manner, the issue of uneven wear concentration that plagues traditional screens is resolved. Any worn or damaged section can be readily replaced with a new one. Consequently, the replacement cost of individual screen sections is significantly lower when compared to a complete screen replacement. Ultimately, the ability to replace a single screen section, versus the entire screen section, saves money for the users of the CDs.

A further benefit of the disclosed design and features is the reduction of solids degradation during operation of CDs. In addition to adopting a sectional screen approach, the use of polyurethane or composite material provides further advantages. The traditional metal-to-metal (flites contact with metal screen) contact in CD operation results in elevated friction levels, leading to solid grinding, dusting, and the creation of finer particles. However, the disclosed features including use of a polyurethane material for the screen provides characteristics of exceptional sliding abilities, effectively reducing the grinding impact on solids. The improved sliding ability in particular is a superior approach to a metal-to-metal typical screen design in applications for water-based drilling fluids.

A further benefit of the disclosed design and features is improved abrasion resistance. The design and features disclosed herein offer a polyurethane or composite molded screen that will have a higher abrasion resistance than steel, even when steel is coated with hard chrome. By using a combination of steel and polyurethane, the disclosed design and features offer longer screen life.

A further benefit of the disclosed design and features is reduced down time needed to service CD equipment. Using the disclosed design and features, the CD will not require complete disassembly when replacement of a screen is necessary due to wear or damage. Instead of having to remove the entire upper section of the CD (the upper protective “water shield” and/or screen cage of the CD) in order to replace a screen, each segment of the CD screen according to the disclosure herein can be removed out of a side of the CD unit through a side access door. In typical CD configurations, the single-unit metal screen replacement operation requires the use of a lifting crane to remove the water-shield and/or the screen cage. In many cases, typical screen replacement operations also require removal of the CD feed system that may overhang the CD. Using the features and design disclosed herein, if a segment of a CD screen requires replacement, a side access door will be opened, and each screen segment may be separately removed and replaced; the upper feed systems will not need to be removed.

It is noted that prior art attempts at providing an improved screen assembly focused on horizontal segmenting of the screen sidewall, in contrast to the vertical segmenting of the screen sidewall as disclosed herein. The past attempts used horizontal segmenting, wherein segments were divided along a line perpendicular to the longitudinal rotational axis of the screen assembly. The past attempts still suffered from the drawback of having to remove the water-shield and/or the screen cage in order to replace a segment of the screen. Such attempts also still suffered the drawback of having to remove a feed system positioned above and overhanging the CD.

A further benefit of the disclosed design and features is that each screen segment is more ergonomically correct for safe handling by a service technician. Using typical current designs of CD screens, service technicians must use a crane to place the heavy and bulky screen into, or extract the screen from, the CD. The disclosure herein provides a lighter, smaller segment that may be more simply and safely handled by a technician conducting a replacement operation.

A further benefit of the disclosed design and features is that the CD screen segments as disclosed herein, as contrasted with typical single-unit CD screens, offer reduced need for extensive and expensive packaging materials, and offer lower shipping costs, more compact storage, and improved inventory management. Given the nature of having a complete screen made from a plurality of individual segments, the packaging will be smaller, and the overall shipping weight will be reduced. This in turn will reduce the cost of shipping and will require storage space to stock the segments in inventory.

In an aspect of this disclosure, there is provided a screen assembly 10 for a cuttings dryer 100, comprising a frame 14 of the screen assembly 10, and a screen 11 of the screen assembly 10, wherein the frame is configured in a frustoconical shape, the frame has a first end (base) having a diameter D1, a second end (top 18) having a smaller diameter D2 than the diameter D1 of the first end (base 16), a plurality of support bars 20, 20 positioned between the first end (base 16) and the second end (top 18), and apertures 21 formed between the support bars 20, 20, the support bars 20 extend substantially along lines formed between the first end of the frame and the second end of the frame, the screen 11 is comprised of a plurality of screen segments 12, 12, and the screen segments 12 have lateral sides 12A detachably mounted onto the support bars on an exterior side of the frame.

In another aspect of the disclosure, the frame further comprises at least one support ring 22 attached to the support bars 20 and positioned between the first end of the frame and the second end of the frame.

In another aspect according to any of the preceding examples, at least one of the support bars substantially aligns with a generatrix of the frustoconical shape of the frame.

In another aspect according to any of the preceding examples, the lateral sides 12A of the screen segments are configured to be proximate to the first end of the frame and to be proximate to the second end of the frame.

In another aspect according to any of the preceding examples, the screen segments 12 are detachably mounted to extend between the first end of the frame and the second end of the frame.

In another aspect according to any of the preceding examples, at least one of the screen segments comprises a metal reinforcement frame 44 molded inside the screen segment.

In another aspect according to any of the preceding examples, at least one of the support bars comprises a stud 26 extending outwardly from the support bar 20 on an exterior surface 20E of the support bar 20, and the stud 26 is configured to engage with an indentation 40 formed in one of the lateral sides 12A of one of the screen segments 12.

In another aspect according to any of the preceding examples, a protruding distal end 26 E of the stud is seated in the indentation 40 in the lateral side 12A of the screen segment 12, and the protruding distal end 26E is engaged in an aperture 30 formed in a lock bar 28 detachably mounted in abutment with the screen segment 12.

In another aspect according to any of the preceding examples, the protruding end 26E of the stud 26 is secured within the lock bar aperture 30 by a locknut 34 detachably affixed to the protruding distal end 26E of the stud 26.

In another aspect according to any of the preceding examples, the plurality of screen segments includes at least three screen segments.

In another aspect according to any of the preceding examples, the cuttings dryer 100 is a vertical cuttings dryer 100.

In an aspect of this disclosure, there is provided a cuttings dryer, comprising a screen assembly 10 for the cuttings dryer 100, comprising a frame 14 of the screen assembly 10, and a screen 11 of the screen assembly 10, wherein the frame is configured in a frustoconical shape, the frame has a first end (base 16) having a diameter D1, a second end (top 18) having a smaller diameter D2 than the diameter D1 of the first end (base 16), a plurality of support bars 20 positioned between the first end (base 16) and the second end (top 18), and apertures 21 formed between the support bars 20, the support bars 20 extend substantially along lines formed between the first end of the frame and the second end of the frame, the screen 11 is comprised of a plurality of screen segments 12, 12, and the screen segments 12 have lateral sides 12A detachably mounted onto the support bars on an exterior side of the frame.

In another aspect according to any of the preceding examples, the screen segments are installed to be accessible from an exterior side of the frame for replacement.

In another aspect according to any of the preceding examples, the dryer is a vertical cuttings dryer. In another aspect according to any of the preceding examples, the dryer includes an access door configured to permit access to remove and replace screen segments.

In another aspect according to any of the preceding examples, at least one of the support bars substantially aligns with a generatrix of the frustoconical shape of the frame.

In another aspect according to any of the preceding examples, the lateral sides 12A of the screen segments are configured to be proximate to the first end of the frame and to be proximate to the second end of the frame.

In another aspect according to any of the preceding examples, the screen segments 12 are detachably mounted to extend between the first end of the frame and the second end of the frame.

In an aspect of this disclosure, there is provided a method of repairing a screen in a cuttings dryer 100, comprising: (A) accessing a screen of the dryer, wherein the dryer comprises a screen assembly that includes a frame 14 of the screen assembly 10, and a screen 11 of the screen assembly 10, wherein the frame is configured in a frustoconical shape, the frame has a first end (base 16) having a diameter D1, a second end (top 18) having a smaller diameter D2 than the diameter D1 of the first end (base 16), a plurality of support bars 20 positioned between the first end (base 16) and the second end (top 18), and apertures 21 formed between the support bars 20, the support bars 20 extend substantially along lines formed between the first end of the frame and the second end of the frame, the screen 11 is comprised of a plurality of screen segments 12, 12, and the screen segments 12 have lateral sides 12A detachably mounted onto the support bars on an exterior side of the frame; (B) removing one of the screen segments; and (C) replacing the removed screen segment with a replacement screen segment.

In another aspect according to any of the preceding examples, the cuttings dryer is a vertical cuttings dryer.

While illustrative examples of the disclosure have been illustrated and described in detail in the drawings and foregoing description, the same is to be considered as illustrative and not restrictive in character, it being understood that only certain examples have been shown and described and that all changes and modifications that come within the spirit of the claimed invention are desired to be protected. It should be understood that while the use of words such as preferable, preferably, preferred or more preferred utilized in the description above indicates that the feature so described may be more desirable, it nonetheless may not be necessary and examples lacking the same may be contemplated as within the scope of the invention, the scope being defined by the claims that follow. In reading the claims, it is intended that when words such as “a,” “an,” “at least one,” or “at least one portion” are used there is no intention to limit the claim to only one item unless specifically stated to the contrary in the claim. When the language “at least a portion” and/or “a portion” is used the item can include a portion and/or the entire item unless specifically stated to the contrary.

One of skill in the art may appreciate from the foregoing that unexpected benefits may be derived from the disclosed features of the subject design, without the need for additional components or parts, or other changes in the configuration of a conventional CD. Changes to configuration as disclosed may add costs, weight, and complexity to manufacture, operation, and maintenance of a CD screen. A key benefit contemplated by the inventors is improvement in features and design, while excluding any additional components or changes in structural features. In this exclusion, maximum cost containment may be affected. Accordingly, the substantial benefits of simplicity of manufacture, operation, and maintenance of may reside in an example of the invention consisting of or consisting essentially of features of the apparatus disclosed herein. Thus, examples of the invention contemplate the exclusion of features, parts, and components beyond those set forth herein.

Reference Numeral List

| | |
|---|---|
| 10 | Screen assembly |
| 10A | Sidewall of screen assembly |
| 11 | Screen |
| 12 | Screen segment |
| 12A | Lateral side of screen segment |
| 14 | Screen frame |
| 16 | Frame base (lower first end of frame) |
| D1 | Diameter of frame base |
| 18 | Frame top (upper second end of frame) |
| D2 | Diameter of frame top |
| 20 | Frame support bar |
| 21 | Aperture between support bars |
| 22 | Frame support ring |
| 24 | Base screen lock ring |
| 26 | Stud |
| 26E | Distal end of stud |
| 28 | Lock bar |
| 30 | Aperture in lock bar |
| 32 | Gripping ribs of lock bar |
| 34 | Locknut |
| 40 | Stud guide (recess or aperture in screen segment) |
| 42 | Molded groove in segment |
| 44 | Inner reinforcement frame in segment |
| 100 | Cuttings dryer |
| 101 | Outer upper cover of cuttings dryer |
| 102 | Access door in upper outer cover of cuttings dryer |
| LA | Longitudinal axis of screen assembly |

What is claimed is:

1. A screen assembly for a cuttings dryer, comprising
a frame of the screen assembly, and
a screen of the screen assembly,
wherein
the frame is configured in a frustoconical shape,
the frame has
a first end having a diameter D1,
a second end having a smaller diameter D2 than the diameter D1 of the first end,
a plurality of support bars positioned between the first end and the second end, and
apertures formed between the support bars,
the support bars extend substantially along lines formed between the first end of the frame and the second end of the frame,
the screen is comprised of a plurality of screen segments, and
the screen segments have lateral sides detachably mounted onto the support bars on an exterior side of the frame.

2. The screen assembly according to claim 1, wherein the frame further comprises at least one support ring attached to the support bars and positioned between the first end of the frame and the second end of the frame.

3. The screen assembly according to claim 1, wherein at least one of the support bars substantially aligns with a generatrix of the frustoconical shape of the frame.

4. The screen assembly according to claim 1, wherein the lateral sides of the screen segments are configured to be proximate to the first end of the frame and to be proximate to the second end of the frame.

5. The screen assembly according to claim 1, wherein the screen segments are detachably mounted to extend between the first end of the frame and the second end of the frame.

6. The screen assembly according to claim 1, wherein at least one of the screen segments comprises a metal reinforcement frame molded inside the screen segment.

7. The screen assembly according to claim 1, wherein at least one of the support bars comprises a stud extending outwardly from the support bar on an exterior side of the support bar, and the stud is configured to engage with an indentation formed in one of the lateral sides of one of the screen segments.

8. The screen assembly according to claim 6, wherein a protruding end of the stud is seated in the indentation in the lateral side of the screen segment, and the protruding end is engaged in an aperture formed in a lock bar detachably mounted in abutment with the screen segment.

9. The screen assembly of claim 7, wherein the protruding end of the stud is secured within the lock bar aperture by a locknut detachably affixed to the protruding end of the stud.

10. The screen assembly according to claim 1, wherein the plurality of screen segments includes at least three screen segments.

11. The screen assembly according to claim 1, wherein the cuttings dryer is a vertical cuttings dryer.

12. A cuttings dryer, comprising:
a screen assembly for the cuttings dryer, comprising
a frame of the screen assembly, and
a screen of the screen assembly,
wherein
the frame is configured in a frustoconical shape,
the frame has
a first end having a diameter D1,
a second end having a smaller diameter D2 than the diameter D1 of the first end,
a plurality of support bars positioned between the first end and the second end, and
apertures formed between the support bars,
the support bars extend substantially along lines formed between the first end of the frame and the second end of the frame,
the screen is comprised of a plurality of screen segments, and
the screen segments have lateral sides detachably mounted onto the support bars on an exterior side of the frame.

13. The cuttings dryer according to claim 12, wherein the screen segments are installed to be accessible from an exterior side of the frame for replacement.

14. The cuttings dryer according to claim 12, wherein the dryer is a vertical cuttings dryer.

15. The cuttings dryer according to claim 12, comprising an access door configured for access to replace screen segments. 16 The cuttings dryer according to claim 12, wherein at least one of the support bars substantially aligns with a generatrix of the frustoconical shape of the frame.

17. The cuttings dryer according to claim 12, wherein the lateral sides of the screen segments are configured to be proximate to the first end of the frame and to be proximate to the second end of the frame.

18. The cuttings dryer according to claim 12, wherein the screen segments are detachably mounted to extend between the first end of the frame and the second end of the frame.

19. A method of repairing a screen in a cuttings dryer, comprising:
(A) accessing a screen of the dryer, wherein the dryer comprises a screen assembly that includes
a frame of the screen assembly, and
a screen of the screen assembly,
wherein
the frame is configured in a frustoconical shape,
the frame has
a first end having a diameter D1,
a second end having a smaller diameter D2 than the diameter D1 of the first end,
a plurality of support bars positioned between the first end and the second end, and
apertures formed between the support bars,
the support bars extend substantially along lines formed between the first end of the frame and the second end of the frame,
the screen is comprised of a plurality of screen segments, and
the screen segments have lateral sides detachably mounted onto the support bars on an exterior side of the frame;
(B) removing one of the screen segments; and
(C) replacing the removed screen segment with a replacement screen segment.

20. The method of claim 18, wherein the cuttings dryer is a vertical cuttings dryer.
